(19) United States
(12) Patent Application Publication
(10) Pub. No.: US 2006/0201994 A1
(43) Pub. Date: Sep. 14, 2006

(54) Bonding mechanism for a heat conduction tube and heat dissipation plate

(76) Inventors: Chun-Heng Lin, Hsin Chuan City (TW); Zhi-Mieng Dai, Taipei City (TW)

Correspondence Address: LEONG C LEI, PMB # 1008, 1867 YGNACIO VALLEY ROAD, WALNUT CREEK, CA, 94598, US

(21) Appl. No.: 11/076,909

(22) Filed: Mar. 11, 2005

(51) Int. Cl. B23K 13/08

(52) U.S. Cl. 228/8

(57) ABSTRACT

A bonding mechanism for a heat conduction tube and heat dissipation plate is disclosed. The bonding mechanism comprises an installation platform, an elevating device, and a height-adjusting device. The installation platform allows the heat dissipation plates to be placed flatly on the surface of the platform and the height adjusting device is for the control of the height of the heat conduction tube. A plurality of heat dissipation plates can be mounted in sequence with a fixed gap onto the heat conduction tube. The bonding mechanism provides a low noise and low vibration and facilitating adjustment of bonding gap of the heat dissipation plates.

### BACKGROUND OF THE INVENTION

(a) Technical Field of the Invention

The present invention relates to a bonding mechanism for a heat conduction tube and heat dissipation plate, and in particular, the bonding mechanism possessing low noise and low vibration and facilitating adjustment of bonding gap of the heat dissipation plates.

(b) Description of the Prior Art

Heat dissipation device, as shown in FIG. 6, is widely used on electronic devices for heat dissipation, and comprises at least one heating tube a mounted to a plurality of heat dissipation plates “b”.

Recent method of bonding a heat conduction tube with heat dissipation plate is by way of a platform mounted with a molding mechanism to punch heat dissipation plates, and using a bonding device to hold the conduction tube to perform an upward and downward and movement, and using a molding mechanism to punch metallic plate into heat dissipation plates. The bonding mechanism is used to bond a plurality of heat plates onto a heat conduction tube as one unit.

The bonding means of the heat conduction tube with the heat dissipation plates, as shown in FIG. 8, comprises an elevating seat 5 having one lateral end mounted with a clipping device 501 for a heat conduction tube such that the heat conduction tube a moves correspondingly with the upward and downward movement of the elevating seat to bond the heat dissipation plats b in sequence. The bottom face of the elevating seat is provided with a fixing peg 502 having stepped block 503, capable of moving nearly. One step of movement of the stepped block 503 constantly decreases the height of the fixed peg 502 so that a plurality of heat dissipation plates is secured to the heat conduction tube “a” at a regular interval.

The drawback of the conventional method is if the bonding gap of the heating dissipation plates needs to be adjusted, appropriate height stepped block 503 format and the changes in operation is laborious. The impact causes by the fixed peg 502 at the stepped block 503 causes the inaccuracy of the gap between the heat dissipation plate and therefore additional noise is produced. In addition, there are inherit problems on the stepped block 503 and therefore it could not provide tight gap bonding of the heat dissipation plates.

In view of the above, it is an object of the present invention to provide a bonding mechanism for a heat conduction tube and heat dissipation plate to overcome the above drawback.

### SUMMARY OF THE INVENTION

The primary purpose of the present invention is to provide a bonding mechanism for a heat conduction tube and heat dissipation plate having an installation platform, an elevating device, and a height adjusting device, characterized in that the installation platform provides flat arrangement of the heat dissipation plate and the platform surface is provided with a through hole allowing the vertical in and out of the heat conduction tube; the elevating device is mounted at one side of the installation platform and is provided with an elevating seat which moves up and down, and the bottom face of the elevating seat is secured with a frame seat mounted with a sliding seat which can be controlled separately up and down movement, and one end of the installation platform adjacent to the sliding seat is a clipping device for holding the heat conduction tube so that the bottom end of the heat conduction tube is pivotally mounted in a vertical position and a section thereof is corresponding to the through hole and is mounted; the height-adjusting device has a screw rod, which drives the sliding seat, mounted at the bottom section of the elevating seat, and a servo motor which drives the screw rod to rotate clockwise and counter-clockwise via transmission elements, and a computer controller mounted at an appropriate position of the elevating device to control ON and OFF of timing, rotating direction and time of the servo motor such that the sliding seat follows the elevation of the elevating seat so that the sliding seat reaches the preset and restores back to the initial height at one step.

Yet another object of the present invention is to provide a bonding mechanism for a heat conduction tube and heat dissipation plate, wherein the installation platform is formed at the feeding-out end of the bottom mold plate of the molding device of the heat dissipation plates.

Still another object of the present invention is to provide a bonding mechanism for a heat conduction tube and heat dissipation plate, wherein the direction of rotation and time of rotation of the screw rod is pre-set at a value via computer controller.

The advantages of the bonding mechanism for a heat conduction tube and heat dissipation plate of the present invention include:
I. low vibration and low noise which can improve the bonding precision and the bonding stability of heat dissipation;
II. applicable to the fabrication of firm bonding gap;
III. easy and rapid bonding gap between heat plate.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of a bonding mechanism for a heat conduction tube and heat dissipation plate of the present invention.

FIG. 2 is a schematic view showing the configuration of the bonding mechanism for a heat conduction tube and heat dissipation plate of the present invention.

FIG. 3 is a schematic view showing the action of the elevating device of the bonding mechanism for a heat conduction tube and heat dissipation plate of the present invention.

FIG. 4 is a schematic view showing the action of the height-adjusting device of the bonding mechanism for a heat conduction tube and heat dissipation plate of the present invention.

FIG. 5 is a schematic view showing a plurality of heat dissipation plates mounted onto a heat conduction tube of the bonding mechanism for a heat conduction tube and heat dissipation plate of the present invention.

FIG. 6 is a perspective view where the heat dissipation plates and the heat conduction tube are combined in accordance with the present invention.

FIG. 7 shows the platform formed as a unit with the feeding out end of the bottom mold plate of the heat dissipation plate mold of the present invention.

FIG. 8 illustrates a prior art bonding means of a heat conduction tube with heat dissipation plates.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

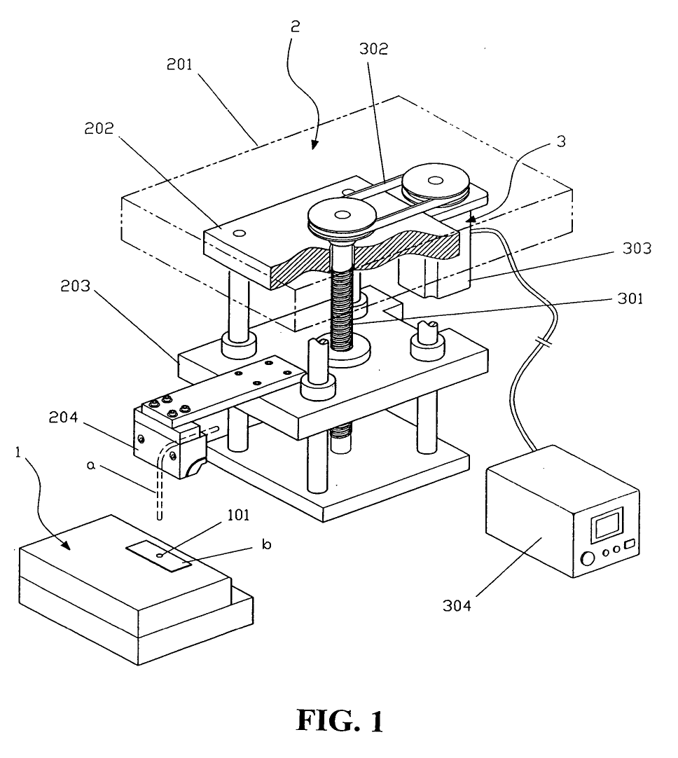

Referring to FIGS. 1, 2 and 6, there is shown a bonding mechanism for a heat conduction tube a and heat dissipation plate b having an installation platform 1, an elevating device 2, and a height adjusting device 3. The installation platform 1 provides flat arrangement of the heat dissipation plate “b” and the platform surface is provided with a through hole 101 allowing the vertical insertion and out from the insertion of the heat conduction tube “a”. The elevating device 2 is mounted at one side of the installation platform 1 and is provided with an elevating seat 201 which moves up and down, and the bottom face of the elevating seat 201 is secured with a frame seat 202 mounted with a sliding seat 203 which can be controlled separately up and down movement, and one end of the installation platform 1 adjacent to the sliding seat 203 is a clipping device 204 for holding the heat conduction tube “a” so that the bottom end of the heat conduction tube a is pivotally mounted in a vertical position and a section thereof is corresponding to the through hole 101 and is mounted. The height-adjusting device 3 has a screw rod 301, which drives the sliding seat 203, mounted at the bottom section of the elevating seat 201, and a servo motor 303 which drives the screw rod 301 to rotate clockwise and counter-clockwise via transmission elements 302, and a computer controller 304 is mounted at an appropriate position of the elevating device 2 to control the ON and OFF timing of the servo motor 303, the rotating direction and time of the servo motor 303 such that the sliding seat 203 follows the up and down movement of the elevating seat 201 so that the sliding seat 203 reaches a preset number of lifting and then restores back to the initial height at one step.

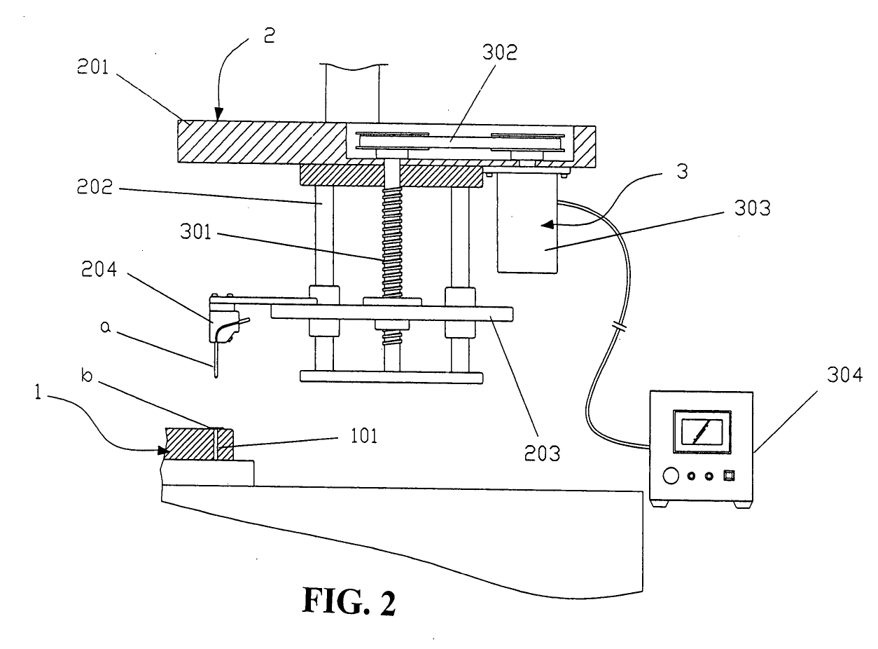

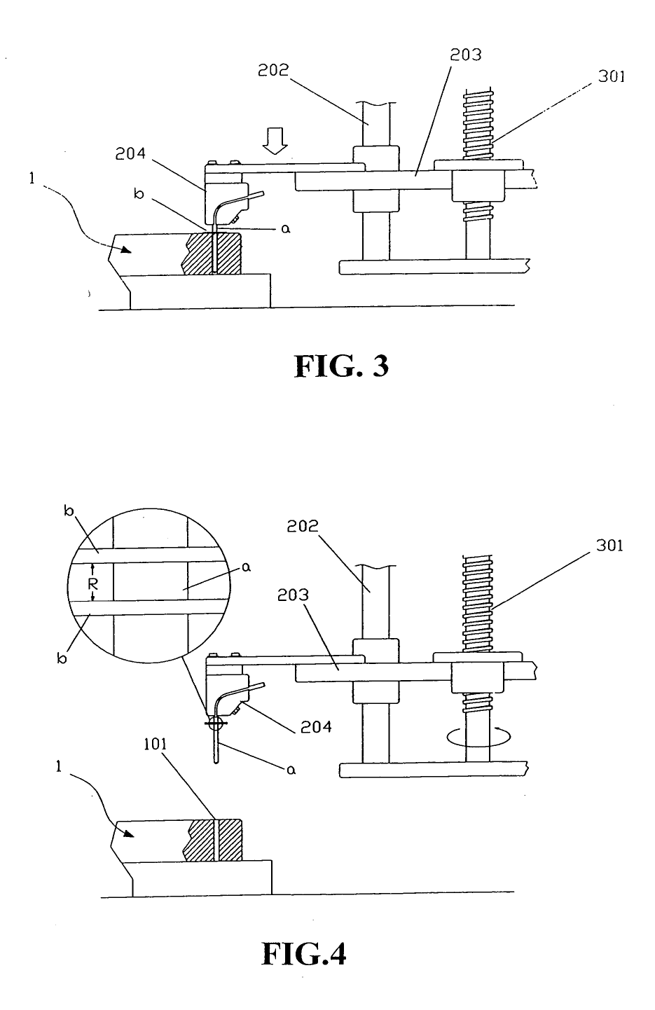

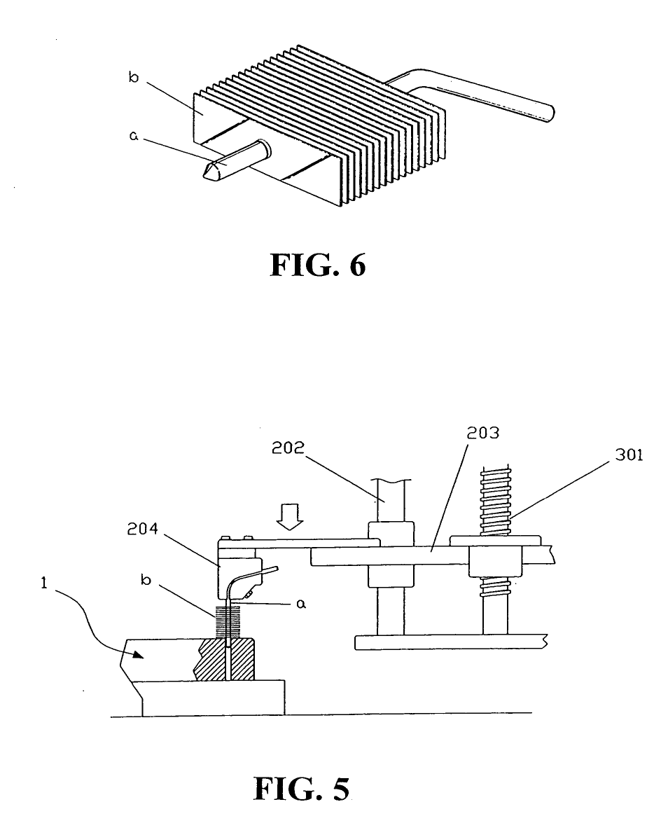

As shown in FIGS. 2 and 5, when in implementation, the operator sets the displacement distance of each elevation of the servo motor 303 driving sliding seat 203 by computer controller 304 based on the number of the heat dissipation plates “a” and the format of the bonding distance R and the number of displacements (equivalent to the number of the heat dissipation plate “b”), after that, a plurality of heat dissipation plates “b” are one by one mounted onto the installation platform 1. The elevating and lowering of the elevation device 2, and the elevating movement of the height adjusting device 3 will continuously mount the heat conduction tube “a”, which is held by the clipping device 204, onto the installation platform 1, and the heat dissipation plates “b” are mounted integrally as one unit. The operator just removes the completed product and replaces with new heat conduction tube.

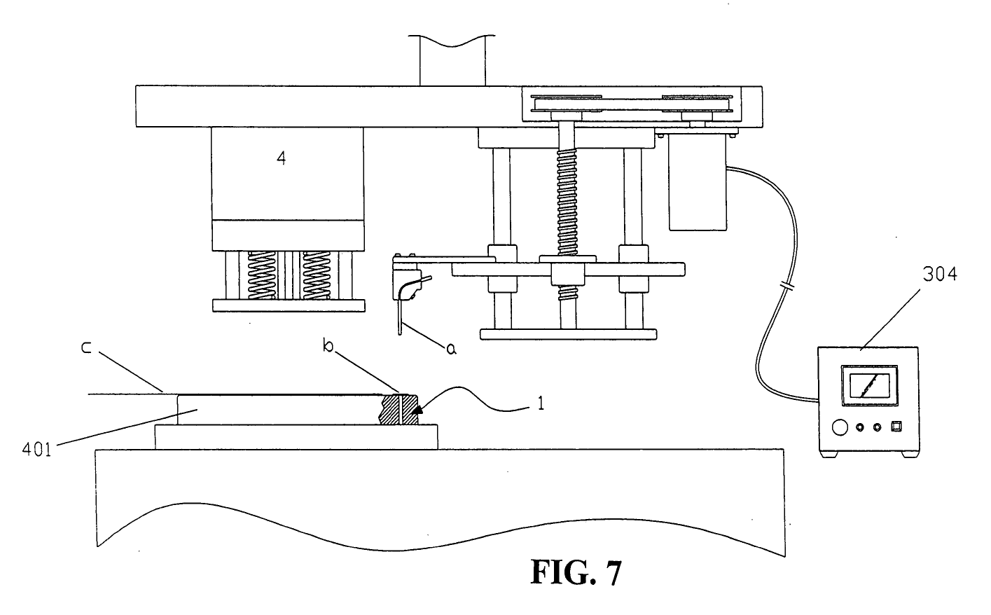

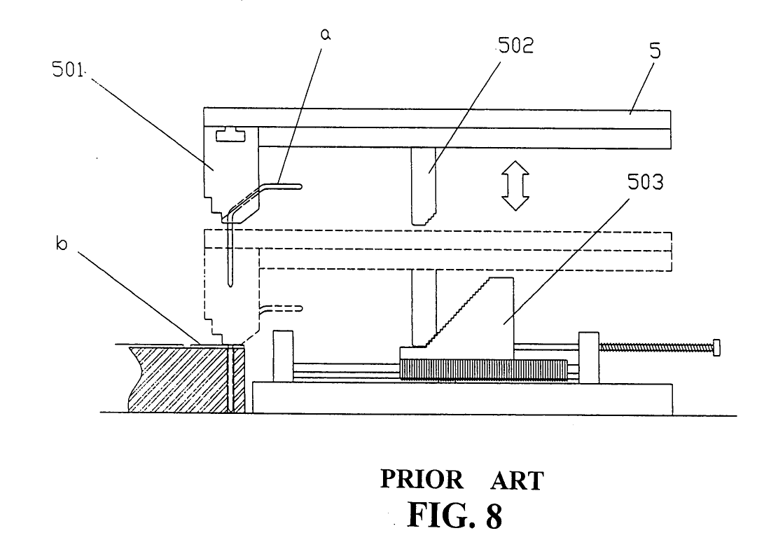

As shown in FIG. 7, the installation platform 1 is directly formed at the feeding-out end of the bottom molding plate 401 of the molding mechanism 4.

The metallic material C is punched using the molding device 4 to form heat dissipation plates “b”. The present bonding device allows smooth process of positioning the heat dissipation plates onto the installation platform 1 by the bonding mechanism directly onto the heat conduction tube as one unit.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A bonding mechanism for a heat conduction tube and heat dissipation plate having an installation platform, an elevating device, and a height adjusting device, characterized in that
the installation platform provides flat arrangement of the heat dissipation plate and the platform surface is provided with a through hole allowing the vertical in and out of the heat conduction tube;
the elevating device is mounted at one side of the installation platform and is provided with an elevating seat which moves up and down, and the bottom face of the elevating seat is secured with a frame seat mounted with a sliding seat which can be controlled separately up and down movement, and one end of the installation platform adjacent to the sliding seat is a clipping device for holding the heat conduction tube so that the bottom end of the heat conduction tube is pivotally mounted in a vertical position and a section thereof is corresponding to the through hole and is mounted;
the height-adjusting device has a screw rod, which drives the sliding seat, mounted at the bottom section of the elevating seat, and a servo motor which drives the screw rod to rotate clockwise and counter-clockwise via transmission elements, and a computer controller mounted at an appropriate position of the elevating device to control ON and OFF of timing, rotating direction and time of the servo motor such that the sliding seat follows the elevation of the elevating seat so that the sliding seat reaches the preset and restores back to the initial height at one step.

2. The bonding mechanism of claim 1, wherein the installation platform is formed at the feeding-out end of the bottom mold plate of the molding device of the heat dissipation plates.

3. The bonding mechanism of claim 1, wherein the direction of rotation and time of rotation of the screw rod is pre-set at a value via computer controller.
